(19) United States
(12) Patent Application Publication
(10) Pub. No.: US 2014/0074497 A1
(43) Pub. Date: Mar. 13, 2014

(54) SELF-RECONCILED MULTI-PART TRANSACTION

(71) Applicant: MasterCard International Incorporated, Purchase, NY (US)

(72) Inventors: Beth M. Griffin, Delafield, WI (US); Bachman Pickett Fulmer, Jr., Cartersville, GA (US); Patti Hughes Velasco, Tallahassee, FL (US)

(21) Appl. No.: 13/959,434

(22) Filed: Aug. 5, 2013

Related U.S. Application Data
(60) Provisional application No. 61/743,817, filed on Sep. 12, 2012.

(51) Int. Cl. G06F 19/00; G06Q 50/22; G06Q 20/10

(52) U.S. Cl. CPC G06F 19/328; G06Q 20/102; G06Q 50/22
USPC 705/2

(57) ABSTRACT

A method for payment reconciliation in an electronic funds settlement transaction network includes receiving a first communication generated by a payer in response to a claim of a provider, the first communication including an explanation of benefits associated with the claim and including personal health information, and instructions to initiate an electronic funds transfer with the ODFI, generating a second communication including a transaction for settling the electronic funds transfer, communicating the second communication to a receiving depository financial institution associated with the provider, generating a third communication including an indication of payment transaction information and the personal health information, wherein the personal health information is encrypted, and communicating the third communication to the provider via an electronic bill payment system.

### CROSS REFERENCE TO RELATED APPLICATION

This application claims priority to U.S. Provisional Patent Application Ser. No. 61/743,817, filed Sep. 12, 2012, the contents of which are hereby incorporated by reference in their entirety.

### FIELD OF THE INVENTION

The present disclosure relates generally to payment reconciliation, and more particularly, to a self-reconciled multi-part transaction.

### BACKGROUND OF THE INVENTION

A number of existing systems seek to enhance the convenience and efficiency of electronic payments. In some contexts, the convenience and efficiency of the electronic payments can be subject to different standards and/or legislation.

In the case of the Affordable Care Act (ACA), the Department of Health and Human Services (HHS) has approved a standard using Electronic Funds Transfer (EFT) and Electronic Remittance Advice (ERA) operating rules for converging financial services and health care.

With the HHS-adopted Healthcare EFT Standards, the EFT and ERA travel separately to a healthcare provider. Here, the ERA travels from a payer (e.g., insurance company) to the healthcare provider directly or through a clearinghouse or other intermediary. Simultaneously, a CCD+ (Cash Concentration or Disbursement Plus Addendum) transaction, initiated by the payer or a third party processer, travels through an ACH (Automated Clearing House) Network from an Originating Depository Financial Institution (ODFI/the payer's bank) to a Receiving Depository Financial Institution (RDFI/the provider's bank). In this context, the provider is required to reassociate the EFT and ERA using a reassociation trace number in order to ensure proper reconciliation.

### SUMMARY OF THE INVENTION

According to an embodiment of the present disclosure, a method for payment reconciliation in an electronic funds settlement transaction network includes receiving a first communication generated by a payer in response to a claim of a provider, said first communication comprising an explanation of benefits associated with said claim and including personal health information, and an electronic funds transfer, generating a second communication comprising a transaction for settling said electronic funds transfer, communicating said second communication to a receiving depository financial institution associated with said provider, generating a third communication comprising an indication of payment transaction information and said personal health information, wherein said personal health information is encrypted, and communicating said third communication to said provider via an electronic bill payment system.

According to an embodiment of the present disclosure, a payment reconciliation entity comprises a receiving module receiving a first communication comprising an explanation of benefits associated with a claim and an electronic funds transfer, wherein said explanation of benefits includes personal health information, a settlement module generating, from said first communication, a second communication comprising a transaction for settling said electronic funds transfer, and a reporting module generating, from said first communication, a third communication comprising an indication of payment transaction information and said personal health information, wherein said personal health information is encrypted.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a tangible computer readable recordable storage medium with computer usable program code for performing the method steps indicated stored thereon in a non-transitory manner. Furthermore, one or more embodiments of the invention or elements thereof can be implemented in the form of a system (or apparatus) including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein.

One or more embodiments of the invention can provide substantial beneficial technical effects, including any one, some, or all of the following: a self-reconciled multi-part transaction, including claim data and payment data in which a record passed between parties to the transaction eliminates the need to re-associate the transaction to a payer originated remittance advice; two transactions can be reconciled and combined into one transaction that is compliant with mandated standards and delivered to a provider; and separately, the transaction, in the form of a CCD+ not containing PHI, can be delivered to the payer's financial institution for funds transfer and settlement to the provider's financial institution.

These and other features and advantages of the present invention will become apparent from the following detailed description of illustrative embodiments thereof, which is to be read in connection with the accompanying drawings.

### BRIEF DESCRIPTION OF THE DRAWINGS

Preferred embodiments of the present disclosure will be described below in more detail, with reference to the accompanying drawings:

FIG. 1 is an illustration of a network of parties to a transaction process according to an embodiment of the present disclosure;

FIG. 2 is a flow diagram of a transaction process according to an embodiment of the present disclosure;

FIG. 3 is a flow diagram of a transaction process according to an embodiment of the present disclosure;

FIG. 4 is a diagram of a system including an electronic bill payment system according to an embodiment of the present disclosure;

FIG. 5 is a diagram of a system including an automated clearing house system according to an embodiment of the present disclosure; and

FIG. 6 is a block diagram depicting an exemplary computer system for processing a multi-part transaction according to an embodiment of the present disclosure.

### DETAILED DESCRIPTION OF PREFERRED EMBODIMENTS

Embodiments of the present disclosure relate to a self-reconciled multi-part transaction, including claim data and payment data. Inventive techniques described herein can be employed in a number of different environments. In one or more embodiments, inventive techniques can be employed in connection with the electronic payment system(s) of MasterCard International Incorporated of Purchase, N.Y., USA.

Non-limiting exemplary embodiments of the present disclosure will be described in the context of multi-part transactions in an Electronic Data Interchange (EDI) environment governed by the Affordable Care Act (ACA). It should be understood that exemplary embodiments are not limited to any regulations, mandates or laws described herein, and that exemplary embodiments can be implemented in a verity of contexts.

Returning to the example of the ACA; the ACA specifies the delivery of, the administration of, and the payment for healthcare services, wherein numerous standards of communication are interweaved with privacy requirements for certain data. In this environment, transactions for payment on services can include a variety of parties, each interacting in different ways and through different flows of information. For example, an ACH (Automated Clearing House) CCD+ (Cash Concentration or Disbursement Plus Addendum) transaction can be used for settlement between payers and providers. In another example, Virtual Card (VC) and Straight-Through Processing (STP), which are exempt from the ACH CCD+ settlement requirement, can be used.

A CCD+ transaction is an exemplary format for healthcare Electronic Funds Transfer (EFT) settlement between payers and financial institutions. The CCD+ is an ACH transaction format currently allowed by the U.S. Department of Health & Human Service (HHS) operating rules when an ACH is used for settlement with a provider. A CCD+ record is a format for electronic transfer of funds and related information, which in one embodiment includes a single 80 byte record with a 15 byte addenda record trace number, and which allows a provider to identify an ERA (Electronic Remittance Advice) record from the payer that matches an EFT payment. In one embodiment, the provider can identify the ERA record from the payer that matches an EFT payment.

The ERA record is a Health Insurance Portability and Accountability Act of 1996 (HIPAA) compliant electronic communication that contains payment data. The ERA record can be considered to be an Explanation of Benefits (EOB) statement. The EOB and ERA are both remittance advices generated by a payer. The EOB is typically a paper remittance advice and the ERA is typically an electronic remittance advice.

ERA transactions contain detailed payment data that can be used to post payments to the correct patient account. According to an exemplary embodiment of the present disclosure, the detailed payment data is extracted from the ERA and an EFT and CCD+ are generated from this data. In this way the ERA and CCD+ are self-reconciled (e.g., the provider is spared the chore of re-associating the ERA and the CCD+). Further, the settlement of a transaction can be structured using an EFT. It is believed that a self-reconciled settlement transaction will advantageously result in a high rate of adoption for ERAs and EFTs, reducing costs and increasing efficiency for payers and providers.

According to an exemplary embodiment of the present disclosure, a payment reconciliation entity posts a transaction using the ERA, formatted as an ANSI X-12 format 835 communication (Health Care Claim Payment/Advice Transaction Set (835), including payment amount (e.g., the amount for settlement, the identity of the provider, the patient and the Receiving Depository Financial Institution (RDFI)) and the claim level data extracted from the ERA.

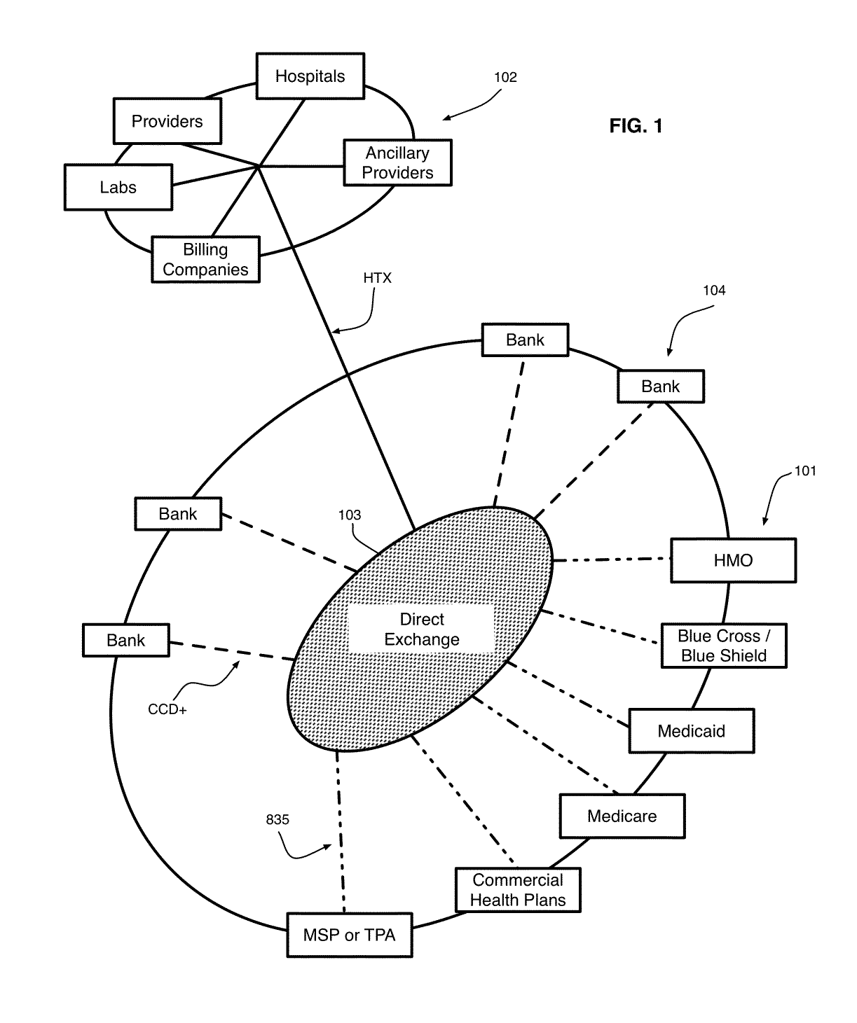

According to an exemplary embodiment of the present disclosure and referring to FIG. 1, a transaction between payers 101 and providers 102 can be facilitated by a direct exchange 103. The payers 101 can include, for example, MSPs (Medical Services Plans), TPA (Third Party Administrator) organizations, commercial health plans, national social insurance programs including Medicare, national health programs including Medicaid, Blue Cross Blue Shield Association (BCBSA) members, HMOs (Health Maintenance Organizations), etc. The providers 102 include, for example, primary care physicians, hospitals, laboratories, etc. The providers 102 can further include agents of the providers, for example, billing companies.

According to an exemplary embodiment of the present disclosure, the direct exchange 103 functions as a transit routing hub for a reconciled combined transaction for ACH settled transactions. The direct exchange 103 can also be a settlement agent for VC and STP transactions for the payers 101, providers 102 and their respective financial institutions 104. As shown in FIG. 1, the direct exchange 103 can process a verity of communications, including HTX communications, which in one embodiment of the present disclosure, are formatted as an enhanced ANSI X-12 835 HIPPA compliant transactions and further include routing information and optionally an indication of when funds are to be available to the provider. The direct exchange 103 can also process CCD+ type communications, other 835 standard communications, etc.

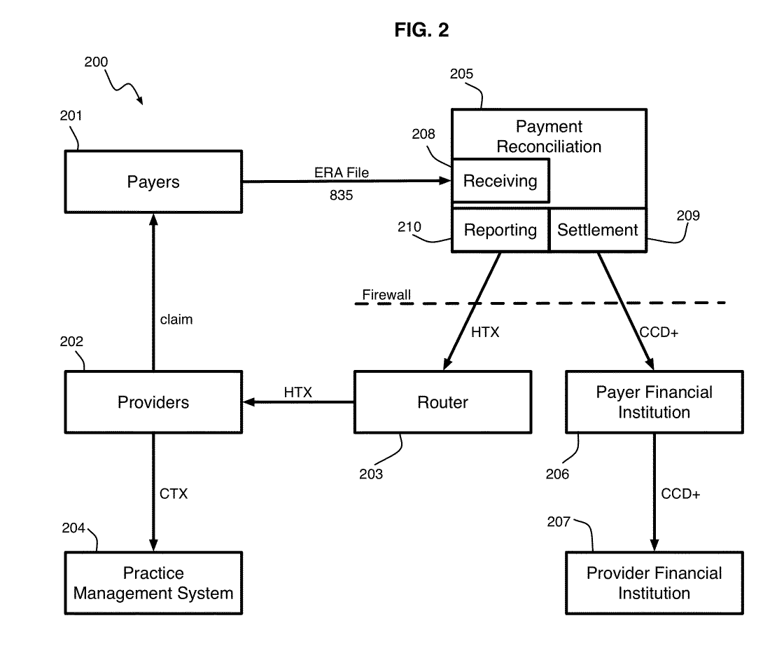

Attention should now be given to FIG. 2, which depicts a process of conducting a transaction 200 according to an exemplary embodiment of the present disclosure. The transaction can be considered to be between a payer 201 and a provider 202. According to an exemplary embodiment of the present disclosure, the transaction is facilitated by a payment reconciliation entity 205 and a router 203.

According to an exemplary embodiment of the present disclosure, the transaction begins with the provider 202 providing a service to a patient. In this embodiment, the provider 202 creates an ANSI X-12 HIPPA compliant claim 837) based on the service provided to the patient. The provider 202 communicates claim data to the payer 201.

The payer 201 receives the claim from the provider 202. According to an exemplary embodiment of the present disclosure, the payer 201 creates an ERA record (e.g., from an EOB file) including claim data. The ERA file can be provided to the payment reconciliation entity 205 in any agreed upon format including an 835 communication, or an HTX communication. (YES)

The ERA is sent to the payment reconciliation entity 205. Where the payment reconciliation entity 205 receives the ERA file (e.g., amounts due for settlement, identity of the provider, RDFI, trace number, and an EFT) and creates the HTX and the ACH CCD+ record from the ERA data.

The payment reconciliation entity 205 forwards the CCD+ back to the payer 201 for presentment to the ODFI 206 or to the ODFI 206 on behalf of the payer 201. That is, according to an exemplary embodiment of the present disclosure, the ERA record includes payment transaction information and a trace number. The trace number can be any indicia capable of differentiating different payment transactions, e.g., an alpha/numeric code. Further, the ERA file can include personal health information (PHI). An ERA file that includes PHI typically invokes the Privacy Rule and/or Security Rules of HIPAA.

The ACH CCD+ record can include the trace number. The ACH CCD+ record can be forwarded to the payer's Originating Depository Financial Institution (ODFI) 206 for settlement to the provider's bank account at its RDFI 207.

A substantially similar process can be used for other transactions, for example, including a VC transaction or a STP transaction. That is, it should be understood that the payment reconciliation entity 205 can use the ERA file to create self-reconciling records for use in ACH, VC, and STP transactions.

According to an embodiment of the present disclosure, the payment reconciliation entity 205 can function as a firewall, operating within the requirements of any legislation, and shielding later actors in the process. That is, the payment reconciliation entity 205 creates the ACH CCD+ record and routes it to the payer financial institution 206 as described above, and further creates a wrapped HTX record, which is self-reconciled to the ACH CCD+ since the HTX and CCD+ are created from the same data extracted from the ERA file. The payment reconciliation entity 205 routes the wrapped HTX record to the router 203.

The wrapped HTX record includes PHI and payment transaction information. The reconciled and wrapped HTX record created by the payment reconciliation entity 205 is an encrypted communication protecting the PHI thereby shielding the router 203 from Covered Entity status under HIPAA Privacy rules. More particularly, the wrapped HTX record exposes only the payment transaction information (e.g., routing information and amounts paid) to the router 203.

According to an exemplary embodiment of the present disclosure, the encryption can be applied such that a header of the HTX record contains routing instructions for ACH settled transactions or routing and settlement instructions in the case of a VC or STP transaction.

The router 203 forwards the wrapped HTX file containing the payment and posting information to the provider 202. Therefore, re-association of the ERA record with the claim is not required.

The ACH CCD+ record created by the payment reconciliation entity 205 can, in one exemplary embodiment, include an 80 byte record that contains the trace number. The payer financial institution 206 can route the ACH CCD+ record to the provider financial institution 207 for deposit to a provider's bank account. Alternatively, in an exemplary embodiment of the present disclosure, the router 203 can perform the functions of the payment reconciliation entity 205, such that the payment reconciliation entity 205 can be removed from the process. In this exemplary embodiment, the router 203 would be a HIPAA Covered Entity.

The wrapped HTX record, which includes payment amounts, is created by the payment reconciliation entity 205 from the ERA record provided by the payer 201, can be self-reconciled to the payment (e.g., the payment made to the provider financial institution 207).

The wrapped HTX record can be used to post data with various levels of detail, including at a CPT® level (Current Procedural Terminology procedure). The wrapped HTX record, received by the router 203, can be routed through an electronic bill payment system, such as the MASTERCARD RPPS® electronic payment system (registered mark of MasterCard International Incorporated, Purchase, N.Y. USA), to the provider 202 or the provider's agent for posting.

In view of the foregoing, the payment reconciliation entity 205 can include various modules. These modules can include a receiving module 208 receiving the ERA file, a settlement module 209 generating, from the ERA, a CCD+, and a reporting module 210 generating, from the ERA, a wrapped HTX.

The MASTERCARD RPPS® system is non-limiting example of a payment system; for example, other types of electronic bill payment systems could be employed in other instances. Thus, references to RPPS in one or more embodiments are not intended to be limiting and other embodiments may be employed in connection with other types of electronic payment systems. For example, U.S. Pat. No. 5,699,528 to Hogan (expressly incorporated herein by reference in its entirety for all purposes) discloses a system and method for bill delivery and payment over a communications network; United States Patent Publication No. 2012-0197788 A1 (expressly incorporated herein by reference in its entirety for all purposes) discloses a transaction processing engine for bill payment transactions and the like, and United States Patent Publication No. 2011-0251952 A1 (expressly incorporated herein by reference in its entirety for all purposes) discloses an apparatus and method for bill presentment and payment.

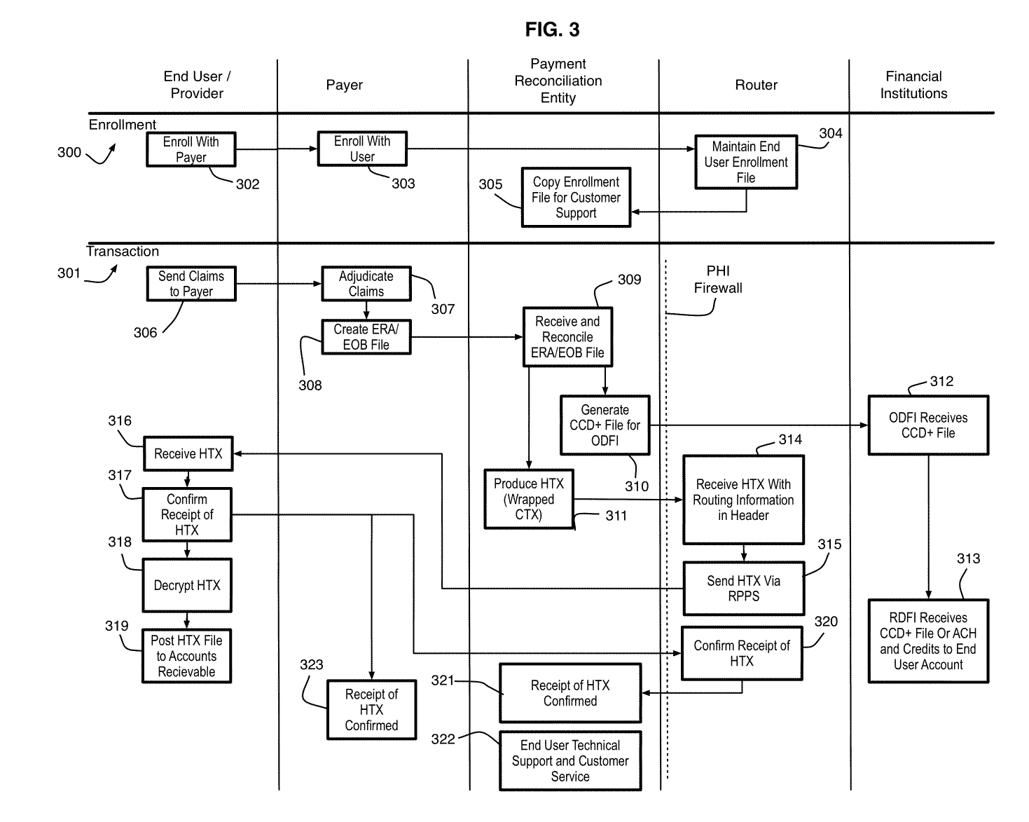

Referring now to FIG. 3, an exemplary transaction will be described according to an exemplary embodiment of the present disclosure in the context of ACH; it should be understood that a flow for alternative transactions, such as an STP transaction, would differ. FIG. 3 can be considered in two phases, including an enrollment phase 300 and a transaction phase 301. In the enrollment phase 300, at 302-303 an end user, e.g., provider, enrolls with a payer, e.g., an insurance company. Based on the enrollment, an end user enrollment file is maintained by the router at 304, a copy of which can be provided to a payment reconciliation entity at 305. Recall that the router 203 can perform the functions of the payment reconciliation entity 205; therefore, block 305 can be optional.

In the transaction phase 301, claim data can be sent to a payer at 306 based on a service provided to a patient by the end user. The payer, having received the claim data, adjudicates the claims 307 and creates an ERA file at 308. The ERA file can be sent to the payment reconciliation entity.

The payment reconciliation entity reconciles the ERA file at 309. The payment reconciliation entity creates an ACH CCD+ record at 310 and a reconciled and wrapped CTX file at 311. The ACH CCD+ record is routed to the payer financial institution at 312. The payer financial institution forwards the ACH CCD+ record to the provider financial institution at 313, where the claim can be settled. Settlements can be managed by the router via a netting process between issuing banks In this case, an RPPS transaction, serviced by the router, would not come under the operating rules of the HHS mandate.

The HTX file (e.g., the reconciled and wrapped CTX file) created at 311 can be communicated to the router at 314, where the HTX file can be processed according to the electronic bill payment system at 315. Note that FIG. 3 refers to MASTERCARD RPPS; as noted elsewhere herein, this is a non-limiting example of an electronic bill presentment and/or payment system.

In the electronic bill payment system, the HTX file can be encrypted at 315 and sent to the end user at 316 (where receipt can be confirmed at 317 to the router (320) and payer (323)); decrypted at 318; and posted to a practice management system at 319.

Furthermore, the router can confirm the end user's receipt of the HTX at 320 and forward the confirmation to the payment reconciliation entity at 321.

The payment reconciliation entity can provide technical support and customer server to the end user at 322.

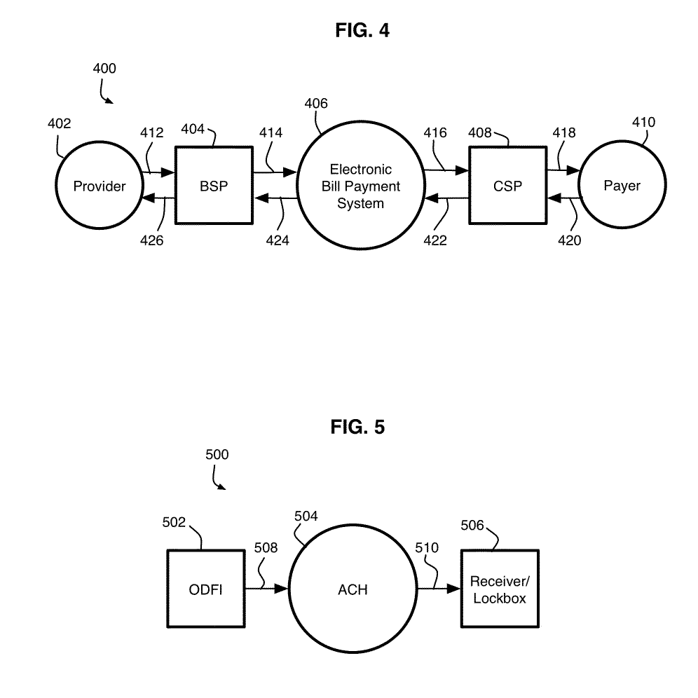

Given the teachings herein, the skilled artisan will be able to implement one or more embodiments of the present disclosure using a variety of techniques. By way of example and not limitation, a self-reconciled settlement transaction can be implemented in a system such as that shown in FIG. 4 using techniques described herein.

As shown in FIG. 4, in a self-reconciled settlement transaction 400, during a presentment phase a biller or provider 402 electronically sends billing information in the form of a medical claim 412 to its biller service provider (BSP) 404; that is, an institution that acts as an intermediary between the biller and the payer for the exchange of electronic bill payment information. BSP 404 in turn sends the information to the electronic bill payment system 406, as seen at 414. As seen at 416, the system 406 in turn delivers the billing information to the customer service provider (CSP) 408, that is, an agent of the payer that provides an interface directly to payers for bill payment and presentment. The CSP enrolls payers, enables payment and presentment, and provides customer care. CSP 408 presents the bill to the payers 410 at 418.

In a payment phase, payer 410 sends bill payment instructions to CSP 408, as seen at 420. CSP 408 in turn sends the bill payment information to the system 406, as at 422. The system sends funds and data electronically to BSP 404, as at 424. The BSP 404 posts payment information to the provider 402, as at 426.

FIG. 5 shows a process 500 for making EFT for bill payment or the like. An originating depository financial institution (ODFI) 502, also known as an originator, sends instructions (e.g., payment data and remittance data) using a network such as the automated clearing house (ACH) 504, Swift, EPN, CHIPS, Fedwire, and the like, as seen at 508. As shown at 510, the ACH or similar network 504 relays the instructions to the RDFI (e.g., receiver or a lockbox), designated 506. In some embodiments, an ACH file format can be used; one non-limiting example of an ACH file format is the NACHA ACH CCD+ file format. Other formats can also be used; for example, extensible markup language (XML). It should be noted that a variety of networks can be used, both public (for example, ACH) and proprietary (for example, the aforementioned MASTERCARD RPPS system).

Given the discussion thus far, it will be appreciated that, in general terms, an exemplary method for payment reconciliation in an electronic funds settlement transaction network, according to an aspect of the present disclosure, includes receiving a first communication generated by a payer in response to a claim of a provider, said first communication comprising an explanation of benefits associated with said claim and including personal health information, and an electronic funds transfer, generating a second communication comprising a transaction for settling said electronic funds transfer, communicating said second communication to a receiving depository financial institution associated with said provider, generating a third communication comprising an indication of payment transaction information and said personal health information, wherein said personal health information is encrypted, and communicating said third communication to said provider via an electronic bill payment system. Both of these paragraphs are confusing to me. Please do a workflow chart for both.

Given the discussion thus far, it will be appreciated that, in general terms, an exemplary payment reconciliation entity comprises a receiving module receiving a first communication comprising an explanation of benefits associated with a claim and an electronic funds transfer, wherein said explanation of benefits includes personal health information, a settlement module generating, from said first communication, a second communication comprising a transaction for settling said electronic funds transfer, and a reporting module generating, from said first communication, a third communication comprising an indication of payment transaction information and said personal health information, wherein said personal health information is encrypted.

According to an exemplary embodiment of the present disclosure, and by way of recapitulation, the HTX transaction can contain both the payment information and the ERA used for posting. The HTX transaction is a self-reconciling transaction set that makes the process of posting payments efficient and effective. The payment transaction and ERA data travel together to the provider. The provider can be relieved of any reconciliation or multiple transaction matching requirements. In some embodiments, the payer's originating bank cannot be compelled by the Department of Health and Human Services (HHS) to comply with the Accountable Care Act (ACA) Section 1104 published operating rules regarding the delivery of EFT transactions. The originating bank may send the provider's receiving bank a generic ACH credit without the addenda record containing the trace number required for matching and reconciliation to the provider's account. Because there is no way to reconcile or match the EFT to the ERA without the addenda record, the receiving bank may not be able to send a CCD+ transaction to the provider.

### System and Article of Manufacture Details

Embodiments of the invention can employ hardware and/or hardware and software aspects. Software includes but is not limited to firmware, resident software, microcode, etc. Software might be employed, for example, in connection with one or more of a terminal; a reader; payment devices such as cards; a host, server, and/or processing center (optionally with data warehouse) of any entity as depicted in the figures; and the like; purely by way of further example and not limitation, the elements (e.g., a receiving module, a settlement module, reporting module) can be implemented by suitable software modules. Firmware might be employed, for example, in connection with payment devices such as cards and/or with a reader. Firmware provides a number of basic functions (e.g., display, print, accept keystrokes) that in themselves do not provide the final end-use application, but rather are building blocks; software links the building blocks together to deliver a usable solution.

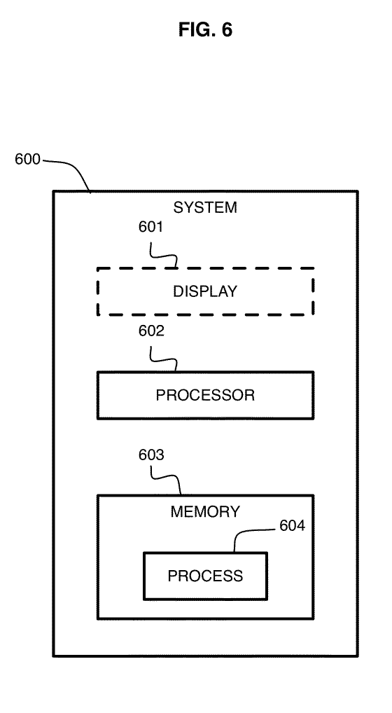

FIG. 6 is a block diagram of a system 600 that can implement part or all of one or more aspects or processes of the invention. As shown in FIG. 6, memory 603 configures the processor 602 (which could correspond, e.g., to processors of hosts and/or servers implementing various functionality or processors associated with any entities as depicted in the figures, and the like) to implement one or more aspects of the methods, steps, and functions disclosed herein (collectively, shown as process 604 in FIG. 6). Different method steps can be performed by different processors. The memory 603 could be distributed or local and the processor 602 could be distributed or singular. The memory 603 could be implemented as an electrical, magnetic or optical memory, or any combination of these or other types of storage devices. It should be noted that if distributed processors are employed, each distributed processor that makes up processor 602 generally contains its own addressable memory space. It should also be noted that some or all of computer system 600 can be incorporated into an application-specific or general-use integrated circuit. For example, one or more method steps could be implemented in hardware in an ASIC rather than using firmware. Display 601 is representative of a variety of possible input/output devices (e.g., displays, mice, keyboards, and the like).

The notation “to/from network” is indicative of a variety of possible network interface devices.

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). For example, one device could be a physical memory media associated with a payment reconciliation entity and another device could be a physical memory media associated with a router of an electronic bill payment system. As used herein, a tangible computer-readable recordable storage medium is intended to encompass a recordable medium, examples of which are set forth above, but is not intended to encompass a transmission medium or disembodied signal.

The computer systems and servers described herein each contain a memory that will configure associated processors to implement the methods, steps, and functions disclosed herein. Such methods, steps, and functions can be carried out, e.g., by processing capability on the various elements, platforms, and so on, processors associated with any entities as depicted in the figures, and the like, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, processors associated with any entities as depicted in the figures; and the like, can make use of computer technology with appropriate instructions to implement method steps described herein. Some aspects can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the invention can include a computer program comprising computer program code means adapted to perform one or all of the steps of any methods or claims set forth herein when such program is run on a computer, and that such program may be embodied on a computer readable storage medium. Further, one or more embodiments of the invention can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 600 as shown in FIG. 6) running a server program. It will be understood that such a physical server may or may not include a display, keyboard, or other input/output components. A “host” includes a physical data processing system (for example, system 600 as shown in FIG. 6) running an appropriate program.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

Thus, aspects of the invention can be implemented, for example, by one or more appropriately programmed general purpose computers, such as, for example, servers or personal computers, located at one or more of the entities in the figures, as well as within the network. Such computers can be interconnected, for example, by one or more of a network, a VPN (Virtual Private Network), the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (an exemplary and non-limiting list), and can also make use of, for example, Extensible Markup Language (XML), known application programs such as relational database applications, spreadsheets, and the like. The computers can be programmed to implement the logic and/or data flow depicted in the figures.

Although illustrative embodiments of the invention have been described herein with reference to the accompanying drawings, it is to be understood that the invention is not limited to those precise embodiments, and that various other changes and modifications may be made by one skilled in the art without departing from the scope or spirit of the invention. For example, items listed as mandatory in some exemplary embodiments may be optional in others, and vice versa.

What is claimed is:

1. A method for payment reconciliation in an electronic funds settlement transaction network comprising:
receiving a first communication generated by a payer in response to a claim of a provider, said first communication comprising an explanation of benefits associated with said claim and including personal health information, and an electronic funds transfer;
generating a second communication comprising a transaction for settling said electronic funds transfer;
communicating said second communication to a receiving depository financial institution associated with said provider;
generating a third communication comprising an indication of payment transaction information and said personal health information, wherein said personal health information is encrypted; and
communicating said third communication to said provider via an electronic bill payment system.

2. The method of claim 1, wherein said indication of payment transaction information further comprises routing information and amounts paid to the receiving depository financial institution.

3. The method of claim 1, wherein said electronic bill payment system further comprises a router.

4. The method of claim 1, wherein said second communication and said third communication are generated from information contained within said first communication.

5. The method of claim 1, further comprising:
generating a trace number; and
inserting said trace number into said second communication and said third communication.

6. The method of claim 1, wherein communicating said second communication to a receiving depository financial institution associated with said provider further comprises communicating said second communication to an originating depository financial institution associated with said payer, wherein said originating depository financial institution provides payment to said receiving depository financial institution settling said claim.

7. The method of claim 1, wherein said first communication comprises a plurality of claims.

8. A payment reconciliation entity comprising:
a receiving module receiving a first communication comprising an explanation of benefits associated with a claim, wherein said explanation of benefits includes personal health information;
a settlement module generating, from said first communication, a second communication comprising a transaction for settling said electronic funds transfer; and
a reporting module generating, from said first communication, a third communication comprising an indication of payment transaction information and said personal health information, wherein said personal health information is encrypted.

9. The payment reconciliation entity of claim 8, wherein said payment reconciliation entity is disposed in electronic communication with:
a payer, said payer generating said first communication;
an originating depository financial institution of said payer; and
an electronic bill payment system including a router routing said third communication to said provider.

10. The payment reconciliation entity of claim 9, further comprising a receiving depository financial institution of a provider disposed in electronic communication with said originating depository financial institution, wherein said provider generates said claim.
